(19) United States
(12) Patent Application Publication
(10) Pub. No.: US 2020/0271861 A1
(43) Pub. Date: Aug. 27, 2020

(54) MULTI-FUNCTION APPARATUS FOR PROCESSING A FIBER OPTIC CABLE AND ASSOCIATED METHOD

(71) Applicant: CORNING RESEARCH & DEVELOPMENT CORPORATION, Corning, NY (US)

(72) Inventors: Chois Alven Blackwell, JR., North Richland Hills, TX (US); Carl Randall Harrison, Decatur, TX (US); Chanh Cuong Vo, Fort Worth, TX (US)

(21) Appl. No.: 16/284,033

(22) Filed: Feb. 25, 2019

(51) Int. Cl. G02B 6/245; G02B 6/25

(52) U.S. Cl. CPC G02B 6/245; G02B 6/25

(57) ABSTRACT

An apparatus for processing a fiber optic cable includes a housing having an inlet for receiving an end of the fiber optic cable. A stripping module is in the housing and configured to remove an end section of an outer jacket of the cable to provide exposed portions of strength members and at least one optical fiber. The apparatus further includes a trimming module in the housing that is configured to remove an end section of the exposed portions of strength members. A method is also disclosed where the stripping and trimming operations for a fiber optic cable are performed by the same apparatus and within the same housing.

### TECHNICAL FIELD

This disclosure relates generally to optical connectivity, and more particularly to an apparatus for processing a fiber optic cable for connection to a fiber optic connector, and an associated method for preparing a fiber optic cable for connection to a fiber optic connector.

### BACKGROUND

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often provided on the ends of fiber optic cables. The process of installing fiber optic connectors on optical fibers from a fiber optic cable is referred to as “termination” or “connectorization,” Connectorization can be done in a factory, resulting in a “pre-connectorized” or “pre-terminated” fiber optic cable, or the field (e.g., using a “field-installable” fiber optic connector).

Regardless of where installation occurs, a fiber optic connector typically includes a ferrule with one or more bores that receive one or more optical fibers. The ferrule supports and positions the optical fiber(s) with respect to a housing of the fiber optic connector. Thus, when the housing of the fiber optic connector is retained in a mating device (e.g., in an adapter), an optical fiber in the ferrule is positioned in a known, fixed location relative to the housing, This allows an optical connection to be established when the optical fiber is aligned with another optical fiber provided in the mating connector.

The assembly of connectors involve several steps, including preparing the end of the fiber optic cable and then mechanically coupling the fiber optic cable to the fiber optic connector. In order to prepare the fiber optic cable for coupling to the connector, an outer protective jacket of the fiber optic cable must be removed to expose a desired length of the optical fiber and strength members that typically surround the optical fiber. The strength members are then trimmed so as to extend only for a portion of the length of the exposed optical fiber. With the fiber optic cable in this arrangement, the exposed optical fiber at the processed end of the cable is stripped of one or more protective coatings and inserted into a connector, such as LC-type and SC-type connector for example, so that the bare glass optical fiber is received in the ferrule of the connector. To complete the connection, the exposed strength members at the processed end of the fiber optic cable are fixed to the connector, such as with a crimp band or other fastener.

While the connectorization process is generally successful for its intended purpose, manufacturers continually strive for improvements in the process. For example, in many applications the steps of removing the outer jacket of the fiber optic cable and trimming the strength members are performed manually, such as by a technician, either in the factory setting or in the field. However, manual processes have certain drawbacks. For example, manual processes are subject to variations in quality because of their dependence on the particular skill and experience of the technician performing the processes. Additionally, manual processes often lack consistency when performing a large number of operations. Furthermore, manual processes typically require a larger workspace foot print in the factory or field and increase the amount of time it takes to complete the connection (e.g., the cycle time).

Attempts have been made to automate the preparation of the fiber optic cable for connection to a fiber optic connector. For example, machines have been developed for removing the outer jacket of the fiber optic cable. Moreover, various trimming machines have also been developed for trimming the strength members to a desired length. Nevertheless, the processing of a fiber optic cable with these machines requires two separate operations performed in different locations and with different equipment. Thus, the workspace foot print remains relatively high even when using these machines. Furthermore, cycle times may not be significantly improved due to lost processing time for moving the fiber optic cable between the separate workstations and properly positioning the fiber optic cable in the machines, which is typically done manually.

### SUMMARY

An apparatus for processing a fiber optic cable for connection to a fiber optic connector is disclosed. The fiber optic cable includes an outer jacket, strength members, and at least one optical fiber. The apparatus includes a housing having an inlet for receiving an end of the fiber optic cable, the inlet providing access to a fiber optic cable path for the fiber optic cable in the housing. A stripping module is positioned in the housing and is configured to remove an end section of the outer jacket from the end of the fiber optic cable to provide exposed portions of the strength members and an exposed portion of the at least one optical fiber. The apparatus further includes a trimming module positioned in the housing and configured to remove an end section of the exposed portions of the strength members. In this way, the stripping and trimming operations of a fiber optic cable are performed by the same apparatus and within the same housing thereof.

In one embodiment, the stripping module includes at least one cable clamp configured to at least partially secure the fiber optic cable relative to the housing and a blade assembly configured to separate the end section of the outer jacket from a main portion of the fiber optic cable at a first separation location. In an exemplary embodiment, the at least one cable clamp includes a first cable clamp positioned adjacent the inlet of the housing and a second cable clamp spaced from first cable clamp, wherein the second cable clamp is configured to engage the fiber optic cable adjacent the end of the fiber optic cable.

In one embodiment, the stripping module may additionally include a cable guide positioned between the first and second cable clamps and configured to at least partially support the fiber optic cable within the housing. The cable guide may include a pair of guide portions positioned on opposing sides of the fiber optic cable path and a cable guide actuator for moving the pair of guide portions relative to each other between an opened position and a closed position. The pair of guide portions are configured to at least partially support the fiber optic cable in the closed position of the pair of guide portions.

In an exemplary embodiment, the first cable clamp may include a first pair of clamp heads positioned on opposing sides of the fiber optic cable path and a first cable clamp actuator for moving the first pair of clamp heads relative to each other between an opened position and a closed position. The first pair of clamp heads is configured to engage the fiber optic cable in the closed position of the first pair of clamp heads. Similarly, the second cable clamp may include a second pair of clamp heads positioned on opposing sides of the fiber optic cable path and a second cable clamp actuator for moving the second pair of clamp heads relative to each between opened and closed positions of the second pair of clamp heads. The second pair of clamp heads is configured to engage the fiber optic cable in the closed position. The first and second guide clamps may be arranged such that the direction of movement of the first pair of clamp heads between the associated opened and closed positions is different than direction of movement of the second pair of clamp heads between the associated opened and closed positions. In one embodiment, the direction of movement of the first pair of clamp heads and the direction of movement of the second pair of clamp heads are offset by about 90 degrees. For example, the direction of movement of the first pair of clamp heads may be in a generally vertical direction and the direction of movement of the second pair of clamp heads may be in a generally horizontal direction.

In an exemplary embodiment, the blade assembly may include a pair of blade bodies positioned on opposing sides of the fiber optic cable path. Each blade body may include a cutting edge configured to engage the fiber optic cable and separate the end section of the outer jacket from the main portion of the fiber optic cable. In one embodiment, the blade assembly may be positioned adjacent the first cable clamp. Additionally, an exemplary embodiment, the blade assembly may be coupled to the first clamp assembly so as to be carried thereby. For example, each blade body of the pair of blade bodies may be mounted to a respective clamp head of the first pair of clamp heads. In a further aspect, each blade body of the pair of blade bodies may be adjustably mounted to the respective clamp head of the first pair of clamp heads.

In an exemplary embodiment, the trimming module may include a collection system positioned to a side of the fiber optic cable path for gathering the exposed portions of the strength members, and a cutting assembly configured to separate the end sections of the exposed strength members at a second separation location. In one embodiment, the collection system may include a vacuum tube having an inlet end positionable adjacent the fiber optic cable path and a vacuum pump coupled to the vacuum tube for generating suction at the inlet end of the vacuum tube to gather the strength member, In one embodiment, the vacuum tube may extend in a direction generally transverse to the fiber optic cable path. The collection system may further include an actuator for moving the vacuum tube between an extended position and a retracted position, wherein the inlet end of the vacuum tube is adjacent the fiber optic cable path in the extended position and is spaced from the fiber optic cable path in the retracted position.

In an exemplary embodiment, the trimming module may further include a clamp assembly positioned to a side of the fiber optic cable path and configured to at least partially secure the exposed portions of the strength members gathered by the collection system. The clamp assembly may be, for example, positioned on the same side of the fiber optic cable path as the collection system. In one embodiment, the clamp assembly includes a pair of clamp heads positioned on opposing sides of the collection system and a clamp assembly actuator for moving the clamp heads relative to each other between an opened position and a closed position. The clamp heads are configured to engage the strength members gathered by the collection system in the closed position. In one embodiment, the vacuum tube is extendable between the clamp heads of the clamp assembly when the clamp heads of the clamp assembly are in the opened position. The vacuum tube, however, may be retracted so as to allow the clamp heads of the clamp assembly to move to the closed position.

In an exemplary embodiment, the cutting assembly may further include a blade having a cutting edge configured to engage the strength members gathered by the collection system and separate the end sections of the exposed portions of the strength members at the second separation location. In one embodiment, the trimming module may further include an actuator for moving the cutting head between an extended position and a retracted position, wherein the cutting edge of the blade is configured to engage the strength members gathered by the collection system when the cutting head is in the extended position.

In another embodiment, a method of processing a fiber optic cable is disclosed. The method includes inserting an end of the fiber optic cable into an inlet of a housing; removing an end section of the outer jacket from the end of the fiber optic cable to provide exposed portions of the strength members and an exposed portion of the at least one optical fiber; and with the fiber optic cable remaining positioned in the housing, removing an end section of the exposed portions of the strength members.

In an exemplary embodiment, removing the end section of the outer jacket may further include clamping the fiber optic cable at a first location adjacent the housing inlet to at least partially secure the fiber optic cable relative to the housing: clamping the fiber optic cable at a second location spaced from the inlet, wherein the second location is adjacent the end of the cable: and separating the end section of the outer jacket from the main portion of the fiber optic cable at a first separation location. In one embodiment, the method may further include supporting the fiber optic cable between the first location and second location. In one embodiment, the steps of clamping the fiber optic cable at the first location and separating the end section of the outer jacket may occur substantially simultaneously. Additionally, the step of clamping the fiber optic cable at the second location may occur before the step of clamping the fiber optic cable at the first location. The method may further include pulling the outer jacket away from the fiber optic cable to provide the exposed portions of the strength members and an exposed portion of the at least one optical fiber. For example, the outer jacket may be pulled in a direction generally parallel to the longitudinal axis of the fiber optic cable.

In an exemplary embodiment, removing the end sections of the exposed strength members may further include gathering the exposed portions of the strength members to one side of the fiber optic cable so that the exposed portions of the strength members extend transverse to the fiber optic cable; and separating the end sections of the strength members from the main portion of the fiber optic cable at a second separation location. The method may further include tensioning the strength members prior to separating the end sections of the exposed portions of the strength members. Additionally, the step of gathering the exposed portions of the strength members may further include using vacuum pressure to gather the exposed portions of the strength members. In one embodiment, the method may further include clamping the gathered exposed portions of the strength members prior to separating the end section of the strength member.

In an exemplary embodiment, separating the end sections of the exposed portions of the strength members may further include engaging a cutting edge of a blade with the strength members.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of a fiber optic cable assembly including a fiber optic cable and a fiber optic connector;

FIG. 2 is an exploded view of the fiber optic cable assembly of FIG. 1;

FIG. 3 is a perspective view of an apparatus in accordance with an embodiment of the disclosure for preparing a fiber optic cable for connectorization;

FIGS. 4A and 4B schematically illustrate partial side cross-sectional and partial top cross-sectional views through the apparatus at an initial point of a processing sequence;

FIGS. 5A and 5B schematically illustrate partial side cross-sectional and partial top cross-sectional views through the apparatus at a subsequent point of a processing sequence;

FIGS. 6A and 6B schematically illustrate partial side cross-sectional and partial top cross-sectional views through the apparatus at another subsequent point of a processing sequence;

FIGS. 7A and 7B schematically illustrate partial side cross-sectional and partial top cross-sectional views through the apparatus at another subsequent point of a processing sequence;

FIGS. 8A and 8B schematically illustrate partial side cross-sectional and partial top cross-sectional views through the apparatus at another subsequent point of a processing sequence;

FIGS. 9A and 9B schematically illustrate partial side cross-sectional and partial top cross-sectional views through the apparatus at another subsequent point of a processing sequence; and

FIGS. 10A and 10B schematically illustrate partial side cross-sectional and partial top cross-sectional views through the apparatus at another subsequent point of a processing sequence.

### DETAILED DESCRIPTION

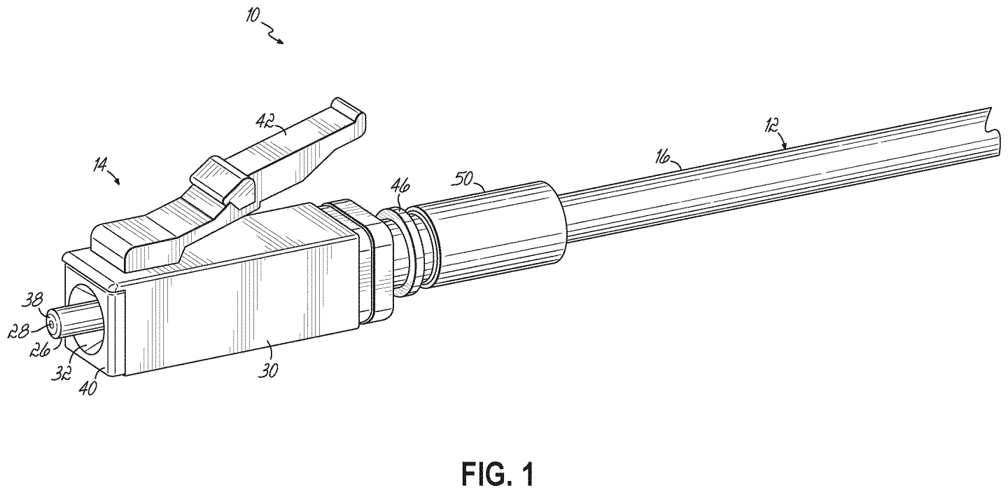

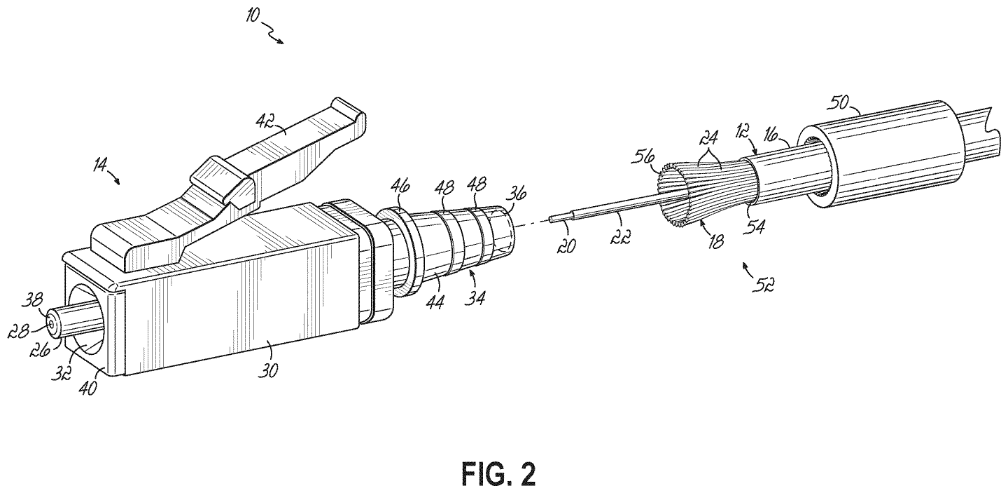

Various embodiments will be further clarified by examples in the description below. In general, the description relates to an apparatus for processing fiber optic cables for connection to fiber optic connectors, and an improved method for achieving such a connection. Referring now to FIGS. 1 and 2, an exemplary fiber optic cable assembly 10 includes a fiber optic cable 12 and a fiber optic connector 14 (also referred to as “optical connector”, or simply “connector”). Although the connector 14 is shown in the form of a LC-type connector, the features described below may be applicable to different connector designs. This includes SC, ST, and MU-type connectors, for example, and other single-fiber or multi-fiber connector designs. Similarly, the illustrated cable 12 is merely an example to facilitate discussion, and persons skilled in optical connectivity will appreciate how different cable designs may be terminated with the connector 14 to provide different fiber optic cable assemblies.

As best shown in FIG. 2, the illustrated fiber optic cable 12 includes an outer jacket 16, strength members 18, and an optical fiber 20, which itself has a buffer layer 22 (“tight buffer”). A portion of the outer jacket 16 has been removed to expose the strength members 18, which are cut or trimmed to a desired length for coupling to the connector 14, as discussed in greater detail below. In the embodiment shown, the strength members 18 comprise a plurality of generally longitudinally extending discrete aramid yarns 24. However, the strength members 18 may take other forms in alternative embodiments, such as a woven arrangement of yarns (not shown).

The illustrated connector 14 includes a ferrule 26 having a ferrule bore 28 (“micro-hole”) configured to support the optical fiber 20, a housing 30 having a cavity 32 in which the ferrule 26 and an associated ferrule holder (not shown) is received, and a connector body 34 (also referred to as “retention body” or “backbone”). In the embodiment shown, the connector body 34 is defined by a rear portion of the housing 30 (i.e., the elements are a unitary structure formed together). The unitary structure may be referred to as either the connector housing or connector body. In alternative embodiments, the connector body 34 may be a separate component coupled to the housing 30. The connector body 34 includes a passageway 36 for allowing the optical fiber 20 to reach the ferrule bore 28. In one embodiment, the connector body 34 is constructed of a plastic material, such as a thermoplastic material. As shown, a front end 38 of the ferrule 26 (“ferrule end face”) projects beyond a front end 40 of the housing 30. The ferrule end face 38 presents an end of the optical fiber 20 for optical coupling with a mating component (e.g., another fiber optic connector: not shown). In this regard, the illustrated connector 14 includes a latch arm 42 for removably coupling the connector 14 to an adapter (not shown).

As shown in FIG. 1, the connector 14 is installed on the fiber optic cable 12 to form the fiber optic cable assembly 10. To this end, the strength members 18 of the cable 12 may extend from the outer jacket 16 over a rear outer surface 44 of the connector body 34. As best shown in FIG. 2, at least the rear outer surface 44 of the illustrated connector body 34 is tapered radially inwardly in a rearward direction such that at least the rear portion of the connector body 34 has a generally frustoconical shape. The illustrated connector body 34 includes an annular barrier 46 delineating the rear portion of the connector body 34 and which may limit the advancement of the strength members 18 and/or other components over the rear outer surface 44, for example. In the embodiment shown, a pair of radially outward protrusions 48 may be positioned on the rear outer surface 44 and extend generally circumferentially thereabout, such that the protrusions 48 may be generally perpendicular to the length of the strength members 18. To assist in retaining the strength members 18 over the connector body 34, a crimp band 50 may be positioned over the strength members 18 and crimped such that the strength members 18 are captured between the connector body 34 and the crimp band 50 to secure the connector 14 onto the end of the cable 12.

As illustrated in FIGS. 1 and 2, and as discussed above, to prepare the fiber optic cable 12 for termination with the connector 14, the end 52 of the cable 12 is processed in a manner that facilitates the connection of the connector 14 to the cable 12. The process of preparing the end 52 of the cable 12 typically includes two primary operations. First, the outer jacket 16 of the cable 12 is removed or stripped to expose a length of the optical fiber 20 and the strength members 18 from an end 54 of the outer jacket 16. Second, the strength members 18 are trimmed such that a desired length of the strength members 18 extends from the end of the outer jacket 16 and a desired length of the optical fiber 20 (and buffer layer 22) extends beyond the end 56 of the strength members 18. Such an arrangement of the cable end 52 is illustrated in FIG. 2 and allows the optical fiber 20 to be stripped of a desired length of any coating (e.g., an acrylic) that remains on the bare glass portion and positioned in the bore 28 of the ferrule 24 while disposing the strength member 18 about the outer surface 44 of the connector body 34 for securement by the crimp band 50.

As discussed above, these operations are typically performed as two separate manufacturing steps and using different equipment. Moreover, in many cases these operations are performed manually. Aspects of the invention are directed to executing these operations in a more efficient and consistent manner. More particularly, an embodiment is disclosed that performs both of these operations (i.e., the stripping of the outer jacket 16 and the trimming of the strength members 18) in a substantially automated manner and using a single, self-contained apparatus. Such an embodiment is beneficial, as it avoids the technician-dependent quality of the connection, reduces lost time due to moving the cable 12 and/or connector 14 between multiple workstations, reduces workspace footprint, reduces cycle time for performing the connection, and provides a reliable and consistent connection between the cable 12 and the connector 14.

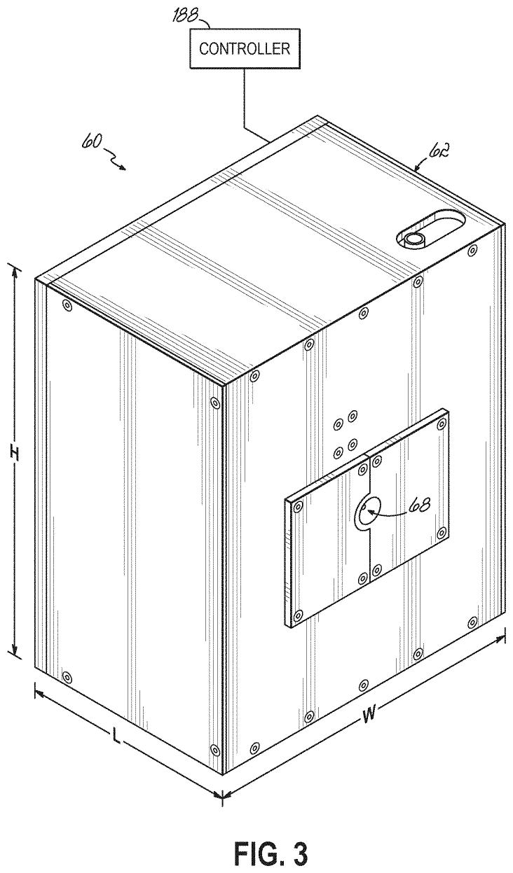

FIG. 3 illustrates such a multi-function apparatus 60 in accordance with an embodiment of the disclosure. The apparatus 60 includes a housing 62 that contains the necessary components for stripping a section of the outer jacket 16 from the cable 12 and trimming the exposed strength members 18. For example, in one embodiment the housing 62 includes a stripping module 64 and a trimming module 66 in the interior space defined by the housing 62. In other words, the same self-contained housing 62 includes both modules 64, 66 for respectively performing the stripping and trimming operations that prepare the cable 12 to be connected to the connector 14. The housing 62 includes an inlet 68 for receiving an (unprocessed) end 52 of a fiber optic cable 12. The insertion of the cable 12 into the inlet 68 may be done manually by a technician, for example. However, once the cable 12 is inserted into the apparatus 60 through the inlet 68, the stripping of the outer jacket 16 and the trimming of the strength members 18 may be substantially performed by the apparatus 60 without manual intervention. The inlet 68 provides access to a fiber optic cable path 70 along which the fiber optic cable 12 extends when positioned in the housing 62.

In an exemplary embodiment, the housing 62 may be generally rectangular in shape and be relatively compact in its size. For example, the housing 62 may be configured to be just slightly larger than a shoe box, thereby being conveniently locatable on a work bench or other work surface within a factory setting or in the field. More particularly, in an exemplary embodiment the footprint of the housing 62 may be between about 300 cm² and about 600 cm², and more preferably about 500 cm². For example, the length L of the housing 62 may be between about 15 cm and about 20 cm, and the width W of the housing 62 may be between about 24 cm and about 30 cm. Additionally, the height H of the housing 62 may be between about 18 cm and about 26 cm. It should be recognized, however, that in alternative embodiments the housing 62 may have a different shape and/or size in order to meet a specific criteria or application. The housing 62 may be formed of a suitable material, such as a metal or a durable plastic. By way of example, the housing 62 may be formed from aluminum or other durable metal. Furthermore, the apparatus 60 may be coupled to an electrical outlet via a plug or the like (not shown). Additionally or alternatively, the apparatus 60 may include one or more batteries (not shown), such as rechargeable batteries, for powering the apparatus 60. This may be useful, for example, in certain field operations.

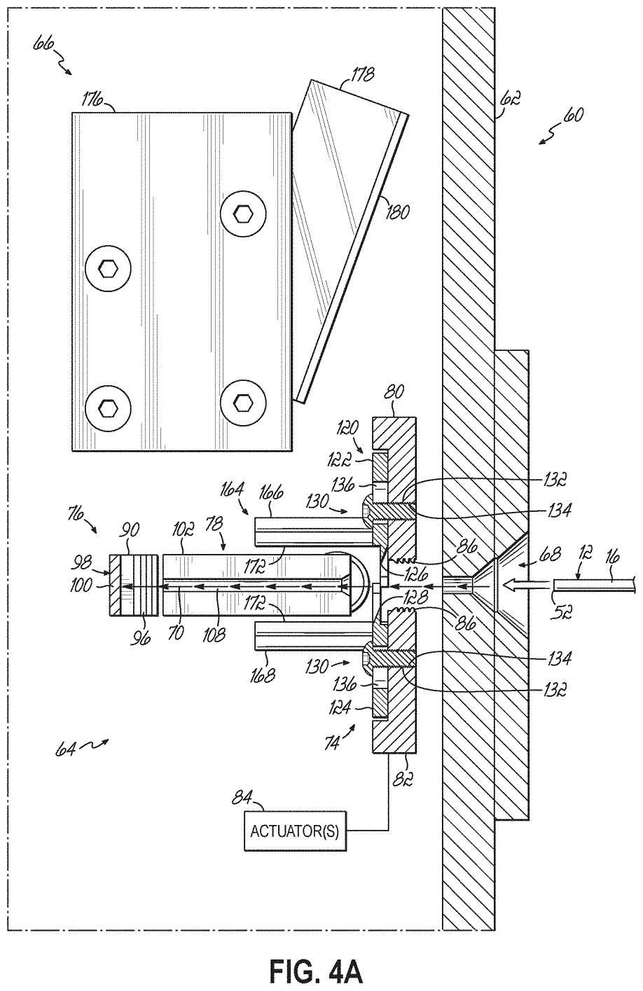

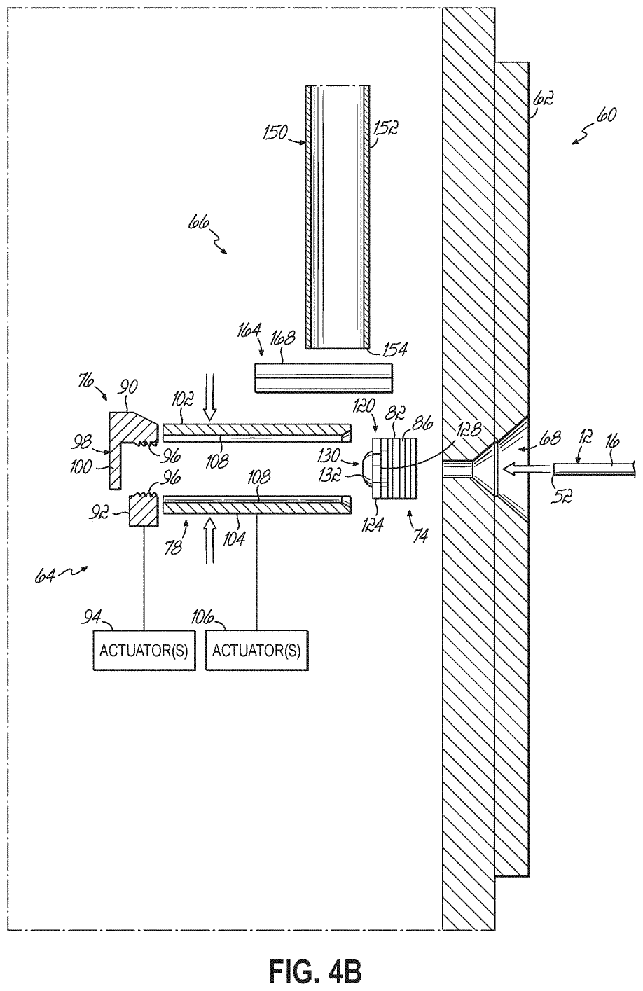

The details of the apparatus 60 and the method of preparing the end 52 of the cable 12 for connection to the connector 14 will be described in reference to FIGS. 4A-10B, which illustrate respective partial side cross-sectional views and partial top cross-sectional views during certain points of the processing sequence. FIGS. 4A and 4B generally illustrate a starting point of the process, wherein the end 52 of an unprocessed cable 12 is inserted into the inlet 68 of the housing 62 of apparatus 60 along fiber optic cable path 70. The stripping module 64 is positioned in the housing and includes a front cable clamp 74 adjacent the inlet 68, a rear cable clamp 76 generally aligned and spaced from the front cable clamp 74, and a cable guide 78 generally aligned with the front and rear cable clamps 74, 76 and disposed therebetween.

Subsequent to the cable 12 being inserted into the housing 62 along cable path 70, the front cable clamp 74 is configured to engage with an outer surface of the cable 12 at a location spaced from the end 52 of the cable 12 to at least partially secure the position of the cable 12 relative to the housing 62. In one embodiment, the front cable clamp 74 includes a pair of clamp heads 80, 82 positioned on opposing sides of the cable 12 when the cable is positioned in the housing 62. The clamp heads 80, 82 are coupled to one or more actuators 84, which may include a wide range of piston, motors, etc., for moving the clamp heads 80, 82 relative to each other. For example, the actuators 84 may be configured to move the clamp heads 80, 82 toward and away from each other to define a closed and opened position, respectively. In one embodiment, both clamp heads 80, 82 may be movable. In an alternative embodiment, however, one clamp head 80, 82 may be stationary while the other clamp head is movable.

In the opened position, the clamp heads 80, 82 are spaced apart from each other a sufficient amount such that the cable 12 is able to be inserted into the housing 62 through inlet 68 and along cable path 70 without being obstructed by the clamp heads 80, 82. In the closed position, the clamp heads 80, 82 are configured to engage the outer surface of the cable 12 to at least partially secure the cable's position relative to the housing 62. For this purpose, the faces of the clamp heads 80, 82 may include gripping features 86, such as ridges, undulations, irregularities, coatings, pads, etc., to enhance the engagement of the clamp heads 80, 82 to the cable 12. The actuators 84 are configured to provide a clamping force or pressure sufficient to at least partially secure the cable 12 to the housing 62 but avoid any damage to the underlying components of the cable 12. Those of ordinary skill in the art will understand how to adjust the clamping force or pressure to achieve the securement without damaging the cable 12.

In a similar manner, subsequent to the cable 12 being inserted into the housing 62 along cable path 70, the rear cable clamp 76 may also be configured to engage with an outer surface of the cable 12 adjacent the end 52 of the unprepared cable 12 to at least partially secure the position of the cable 12 relative to the housing 62. In one embodiment, the rear cable clamp 76 includes a pair of clamp heads 90, 92 positioned on opposing sides of the cable 12 when the cable is positioned in the housing 62. The clamp heads 90, 92 are coupled to one or more actuators 94, which may include a wide range of piston, motors, etc., for moving the clamp heads 90, 92 relative to each other. For example, the actuators 94 may be configured to move the clamp heads 90, 92 toward and away from each other to define a closed and opened position, respectively. In one embodiment, both clamp heads 90, 92 may be movable. In an alternative embodiment, however, one clamp head 90, 92 may be stationary while the other clamp head is movable.

In the opened position, the clamp heads 90, 92 are spaced apart from each other a sufficient amount such that the cable 12 is able to be inserted into the housing 62 through inlet 68 and along cable path 70 without being obstructed by the clamp heads 90, 92. In the closed position, the clamp heads 90, 92 are configured to engage the outer surface of the cable 12 to at least partially secure the cable's position relative to the housing 62. For this purpose, the faces of the clamp heads 90, 92 may include gripping features 96, such as ridges, undulations, irregularities, coatings, pads, etc., to enhance the engagement of the clamp heads 90, 92 to the cable 12. The actuators 94 are configured to provide a clamping force or pressure sufficient to at least partially secure the cable 12 to the housing 62 but avoid any damage to the underlying components of the cable 12. Those of ordinary skill in the art will understand how to adjust the clamping force or pressure to achieve the securement without damaging the cable 12.

In one embodiment, the direction in which the front cable clamp 74 and the rear cable clamp 76 move between the opened and closed positions may be offset from each other. For example, the front cable clamp 74 may move in a substantially vertical direction between the opened and closed positions, while the rear cable clamp 76 may move in a substantially horizontal direction between the opened and closed positions, Such an arrangement of the front and rear cable clamps 74, 76 is illustrated in the figures. It should be recognized, however, that the offset angle in the clamping direction between the front and rear cable clamps 74, 76 may be greater or less than 90 degrees in alternative embodiments.

In addition to the above, the rear cable clamp 76 includes a stop feature 98 that limits the distance the cable 12 may be inserted inside housing 62 through inlet 68 and along cable path 70. In one embodiment, the stop feature 98 may include an abutment wall 100 configured to engage with the end 52 of the cable 12 as the cable is inserted into the housing 62. When the technician feels resistance to the insertion of the cable 12, the technician will understand that the end 52 of the cable 12 abuts the wall 100, and thus the cable 12 is fully inserted into the housing 62 of the apparatus 60. The distance between the inlet 68 and the stop feature 98, such as the abutment wall 100, may be predetermined depending on several factors including the connector type, size of cable, or other related factors. In any event, when the end 52 of the cable 12 engages the stop feature 98, the apparatus 60 is ready to be energized so as to perform the stripping and trimming operations, as discussed in more detail below.

In an exemplary embodiment, the cable guide 78 is intermediate the front and rear cable clamps 74, 76 and is configured to support the cable 12 when it is positioned inside the housing 62 of the apparatus 60. In one embodiment, the cable guide 78 includes a pair of guide portions 102, 104 positioned on opposing sides of the cable 12 when the cable is positioned in the housing 62. The guide portions 102, 104 are coupled to one or more actuators 106, which may include a wide range of piston, motors, etc., for moving the guide portions 102, 104 relative to each other. For example, the actuators 106 may be configured to move the guide portions 102, 104 toward and away from each other to define a closed and opened position, respectively. In one embodiment, both guide portions 102, 104 may be movable. In an alternative embodiment, however, one guide portion 102, 104 may be stationary while the other guide portion is movable.

In the opened position, the guide portions 102, 104 are spaced apart from each other a sufficient amount such that the cable 12 is able to be inserted into the housing 62 through inlet 68 and along the cable path 70 within being obstructed by the guide portions 102, 104, In the closed position, the guide portions 102, 104 may be configured to engage the outer surface of the cable 12 to at least partially support the cable's position relative to the housing 62. More particularly, each guide portion 102, 104 may include a recess 108, such as a semi-circular groove, such that when the guide portions 102, 104 are in the closed position, a passageway 108 is formed through the cable guide 78 for receiving the cable 12 therethrough. In an exemplary embodiment, the cable guide 78 does not provide a clamping force or pressure on the cable 12, but merely supports the cable 12 in the housing 62. In an alternative embodiment, however, the guide portions 102, 104 may be configured to provide a slight clamping force or pressure on the outer surface of the cable 12, The clamping force or pressure provided by the cable guide 78 may be less than that provided by the rear cable clamp 76. Those of ordinary skill in the art will understand how to adjust the clamping force or pressure provided by the cable guide 78 to meet a desired application.

In one embodiment, the direction in which the guide portions 102, 104 move between the opened and closed positions may be the same as the rear cable clamp 76, For example, the guide portions 102, 104 may move in a substantially horizontal direction between the opened and closed positions. Such an arrangement is illustrated in the figures, for example. It should be recognized, however, that the direction in which the guide portions 102, 104 move between the opened and closed positions may be other than substantially horizontal. For example, the guide portions may move in a substantially vertical direction similar to the front cable clamp 74. Other directions may also be possible, In one embodiment, the actuators 106 that cause movement of the guide portions 102, 104 and the actuators 94 that cause movement of the clamp heads 90, 92 may be different and independent of each other, such that each is independently controllable. In an alternative embodiment, the actuators 106 and 94 may be the same actuators such that the movements of the rear cable clamp 76 and the cable guide 78 between the opened and closed positions are not independent of each other but instead occur together.

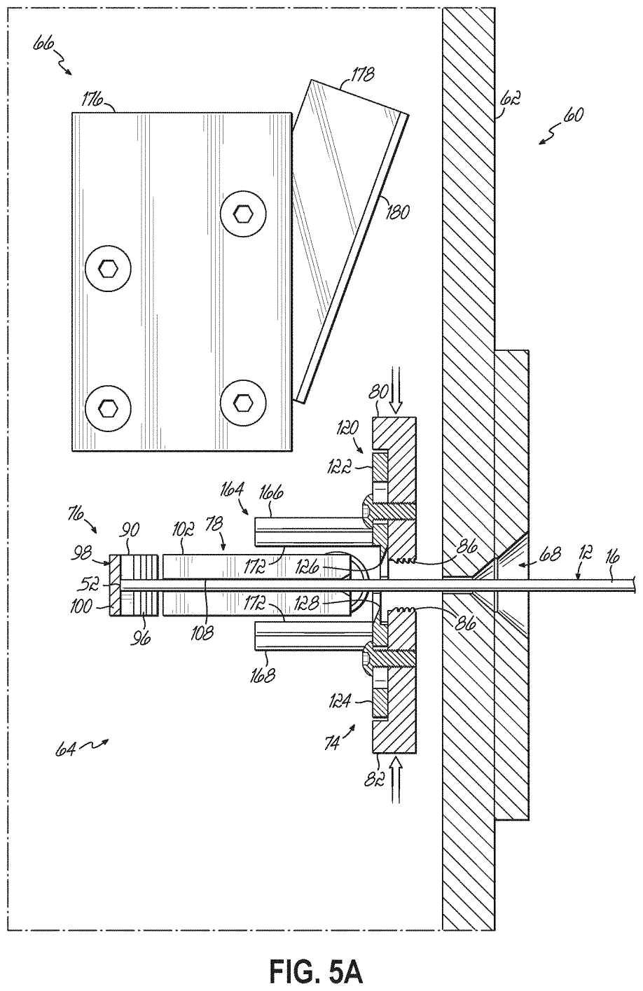

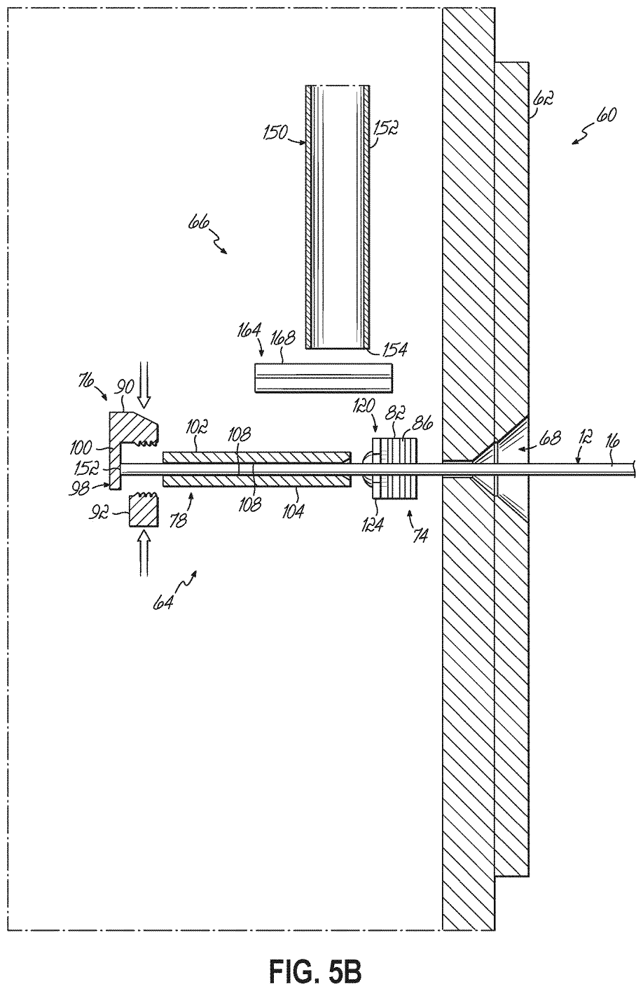

In one embodiment, the apparatus 60 may initially be in a ready position wherein the front cable clamp 74, rear cable clamp 76 and cable guide 78 are all in their opened positions so that the apparatus 60 may freely receive a portion of cable 12 therein. Alternatively, in the ready position the cable guide 78 may be in the closed position since the cable guide 78 provides a path for the cable 12 to pass therethrough. In this way, the cable guide 78 may support the cable 12 during the insertion of the cable 12 into the housing 62. When in the ready position, a technician holds an unprocessed cable 12 and inserts the end 52 into the housing 62 of the apparatus 60 via the inlet 68. The technician then continues to feed the cable 12 into the housing 62 along the cable path 70 until the end 52 of the cable 12 engages the abutment wall 100 of the rear cable clamp 76 (see FIGS. 4A-5B), At this point, the front cable clamp 74, rear cable clamp 76 and the cable guide 78 (if not already in the closed position) may be moved to their closed positions so as to secure and/or support the cable 12 within the housing 62. The movement of these components to the closed position may occur simultaneously or sequentially. For example, in one embodiment, the rear cable clamp 76 may be moved to the closed position prior to the front cable clamp 74 being moved to the closed position. The cable guide 78 may be moved to the closed position either before or after the rear cable clamp 76 is moved to the closed position and is preferably moved to the closed position prior to the front cable clamp 74 being moved to the closed position.

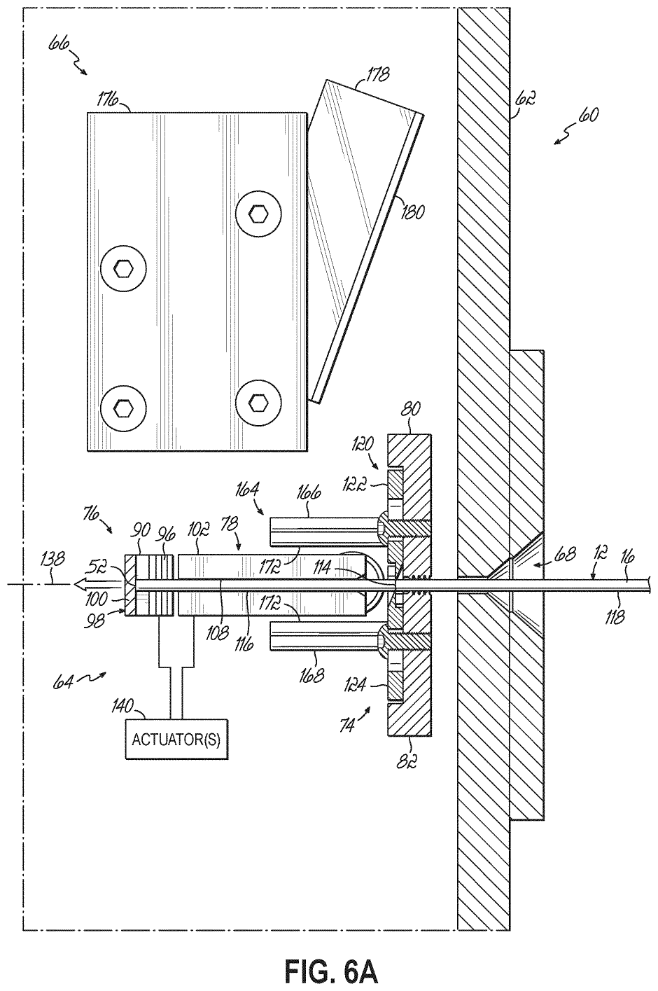

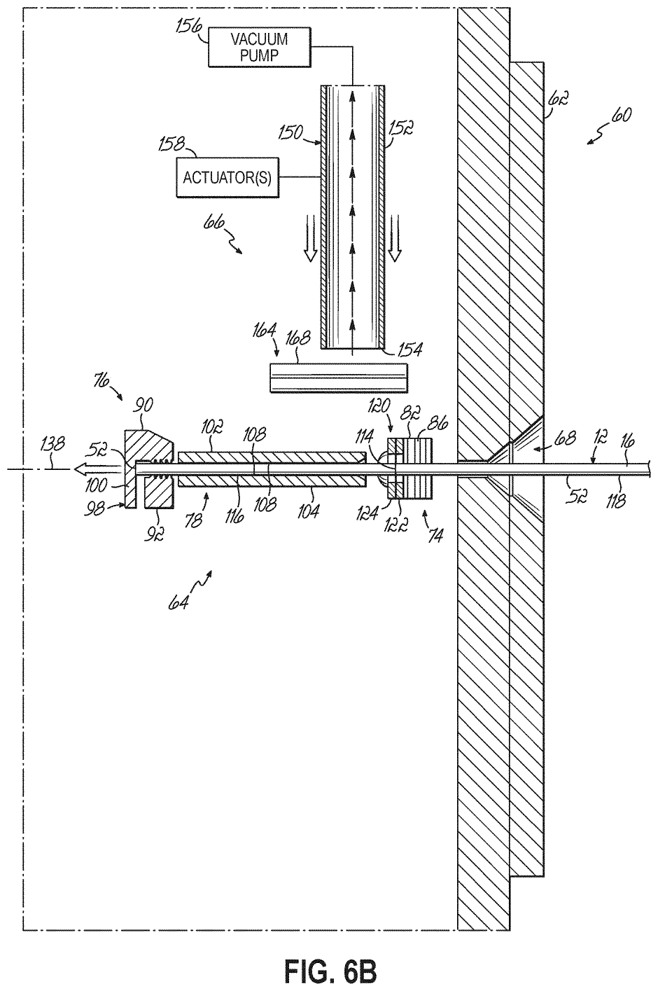

With the cable 12 secured and/or supported relative to the housing 62 of the apparatus 60, the apparatus 60 may be configured to sever the outer jacket 16 of the cable 12 at a first separation location or cutline 114 so as to separate an end section 116 of the outer jacket 16 from the main portion 118 of the cable 12. For this purpose, the apparatus 60, and more particularly the stripping module 64, may include a blade assembly 120 for separating the outer jacket 16 at the cutline 114. In one embodiment, the blade assembly 120 includes a pair of blade bodies 122, 124 positioned on opposing sides of the cable 12 when the cable is positioned in the housing 62. Each blade body 122, 124 includes one or more respective cutting edges 126, 128 configured to engage the outer surface of the cable 12 to effectuate the separation of the outer jacket 16 at the cutline 114. For example, the cutting edges 126, 128 may be have a v-shaped or u-shaped arrangement so as to engage the outer surface of the cable 12 along a substantial portion, if not all, of the cable's circumference. In this way, the outer jacket 16 is easily separated at the cutline 114. In an exemplary embodiment, the blade assembly 120 may be positioned in close proximity to the front cable clamp 74. More particularly, the blade assembly 120 may be immediately adjacent the front cable clamp 74 (FIG. 6A). Similar to the above, the blade bodies 122, 124 may be configured to move toward and away from each other to define a closed position and an opened position, respectively, In one embodiment, both blade bodies 122, 124 may be movable. In an alternative embodiment, however, one blade body 122, 124 may be stationary while the other blade body is movable.

In the opened position, the blade bodies 122, 124 are spaced apart from each other a sufficient amount such that the cutting edges 126, 128 do not engage the outer surface of the cable 12 and the cable is allowed to pass by the blade assembly 120 without cutting or otherwise damaging the cable 12 (FIG. 5A). In the closed position, the cutting edges 126, 128 of the blade bodies 122, 124 are configured to engage the outer surface of the cable 12 to separate the end section 116 of the outer jacket 16 from the main portion 118 of the cable 12 at the cutline 114 (FIG. 6B). In a preferred embodiment, the blade assembly 120 may be coupled to the front cable clamp 74 such that movement of the clamp heads 80, 82 between the opened and closed positions also moves the blade bodies 122, 124 between the opened and closed positions, respectively. For example, the blade bodies 122, 124 may be carried by and mounted to respective clamp heads 80, 82, Thus, the actuators 84 that move the clamp heads 80, 82 between the opened and closed positions also move the blade bodies 122, 124 between their opened and closed positions.

When the front cable clamp 74 is in the closed position, the blade bodies 122, 124 are positioned relative to the clamp heads 80, 82 such that the cutting edges 126, 128 penetrate through the thickness of the outer jacket 16 but do not penetrate through the strength members 18 or other structure inboard of the outer jacket 16. In other words, the positioning of the blade bodies 122, 124 is relatively precise so that substantially only the outer jacket 16 is separated from the main portion 118 of the cable 12 at the cutline 114. To achieve this precision, the blade bodies 122, 124 may be adjustably mounted to the clamp heads 80, 82 via an adjustment mechanism 130. In an exemplary embodiment, the adjustment mechanism 130 includes a fastener 132, such as a screw, for mounting the blade bodies 122, 124 to a respective clamp head 80, 82, via a threaded bore 134, for example. The adjustment mechanism 130 further includes a slotted aperture 136 formed through the blade bodies 122, 124 and oriented so as to extend in a direction parallel to the direction of movement of the clamp heads 80, 82 (e.g., in the vertical direction). The fastener 132 is configured to extend through the slotted aperture 136 and into the threaded bore 134 as illustrated in the figures.

To adjust the position of the blade bodies 122, 124 relative to the clamp heads 80, 82, the fastener 132 may be loosened and the blade bodies 122, 124 slightly moved toward or away from the opposing clamp heads 80, 82, thus moving the fastener 132 along the slotted aperture 136. The fastener 132 may then be re-tightened to fix the position of the blade body 122, 124 relative to the clamp heads 80, 82 when the desired position is reached. While the exemplary embodiment described above mounts the blade assembly 120 to the front cable clamp 74, the invention is not so limited. For example, in an alternative embodiment, the blade assembly 120 may include one or more actuators (not shown) that control movement of the blade bodies 122, 124 between the opened and closed positions independent of movement of the clamp heads 80, 82 via actuators 84.

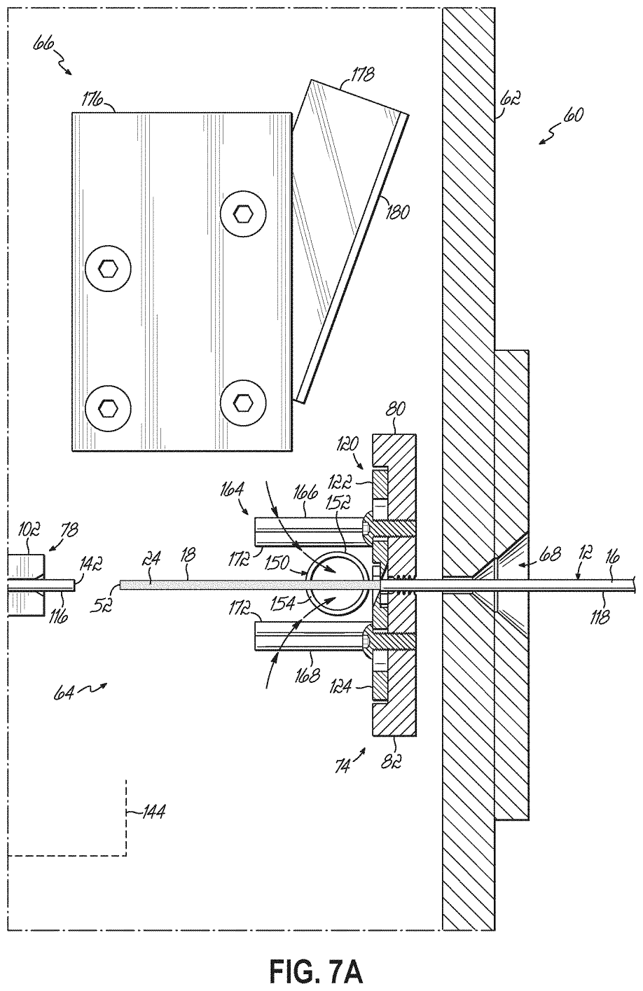

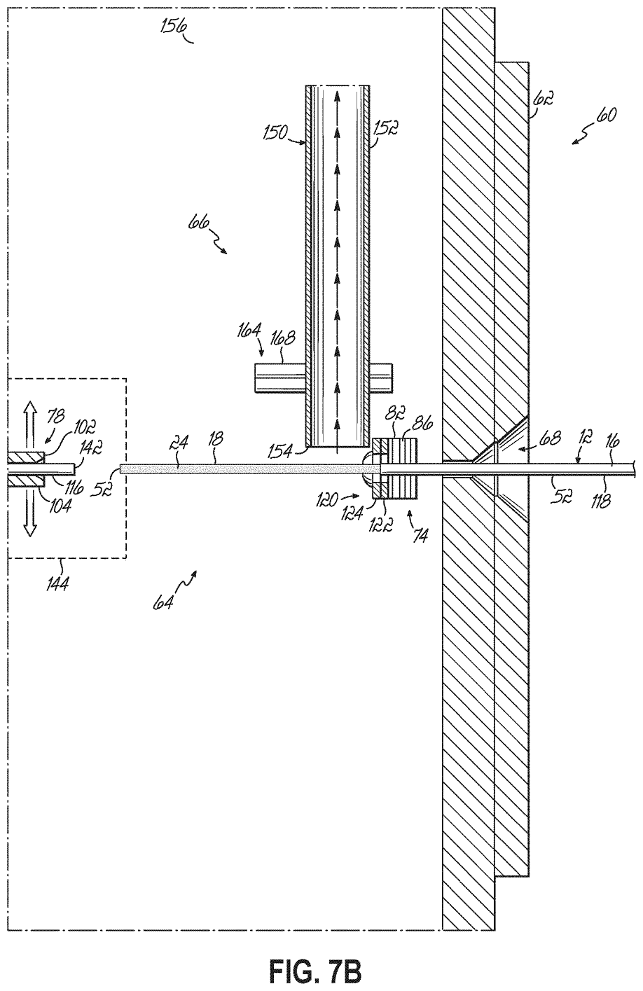

When the front cable clamp 74 is moved to the closed position, the end section 116 of the outer jacket 16 is separated from the main portion 118 of the cable 12 at the outline 114, and therefore may be removed or stripped from the inboard portions of the cable 12, including the strength members 18 and the optical fiber 20, to expose these remaining portions of the cable 12. This may be achieved, for example, by maintaining the front cable clamp 74, rear cable clamp 76 and the cable guide 78 in the closed position and moving the rear cable clamp 76 and the cable guide 78 in a direction generally parallel to a longitudinal axis 138 of the cable 12 (which lies along the cable path 70) and away from the front cable clamp 74 (see FIGS. 6A-7B). In one embodiment, the rear cable clamp 76 and the cable guide 78 may be coupled to a common frame or carriage (not shown) such that these components move together along the longitudinal axis 138. One or more actuators 140 (FIG. 6A) may be coupled to the carriage for moving the rear cable clamp 76 and cable guide 78 away from the front cable clamp 74. The carriage is configured to move a distance such that a trailing end 142 (i.e., formed by the cutline 114) of the end section 116 of the outer jacket 16 is located beyond the end 52 of the exposed remaining portion of the cable 12.

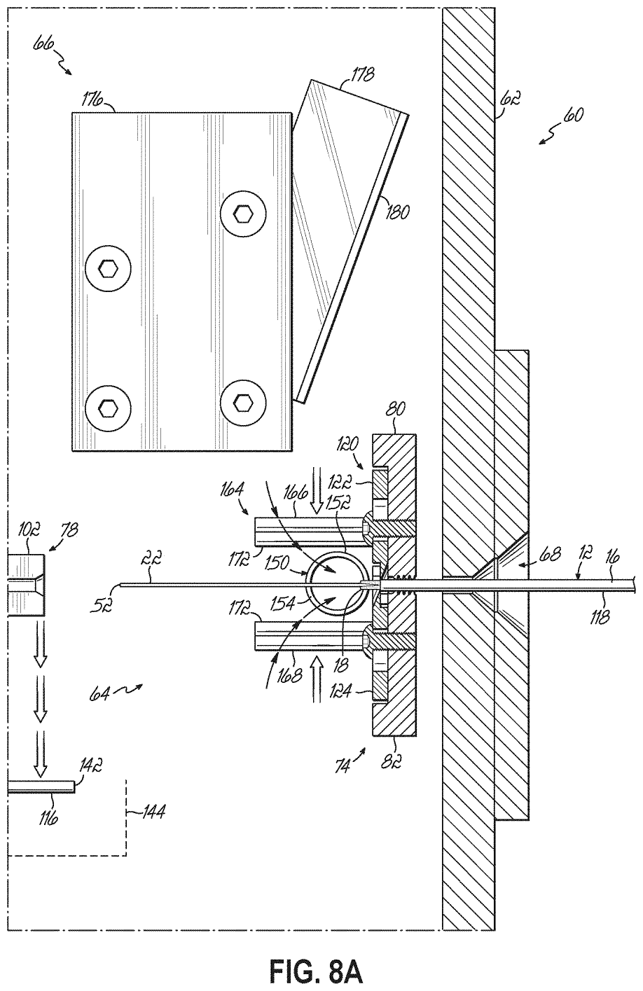

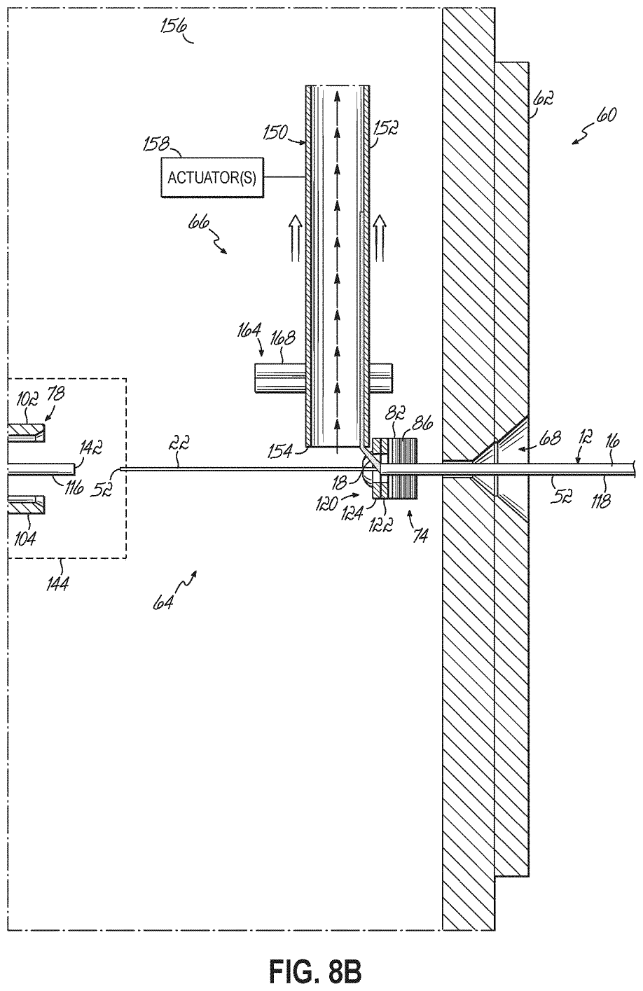

At this point, the rear cable clamp 76 and the cable guide 78 may be moved to their opened positions so that the end section 116 of the outer jacket 16 may be released from the stripping module 64 and appropriately discarded (see FIGS. 7A-8B). For example, due to the horizontal orientation of the clamp heads 90, 92 and guide portions 102, 104, once the rear cable clamp 76 and the cable guide 78 are moved to their opened position, the end section 116 may be released under the influence of gravity and fall into a bin 144 positioned beneath these components and within the housing 62 of the apparatus 60. Periodically, the bin 144 may be removed from the housing 62 and the contents appropriately discarded. Thus, stripping the outer jacket 16 from the cable 12 is a clean and organized process within the apparatus 60.

As illustrated in FIGS. 7A and 7B, once the outer jacket 16 has been stripped from the cable 12, the strength members 18 and the optical fiber 20 (including the buffer layer 22) are exposed. As previously discussed, to connect the cable 12 to the connector 14, the strength members 18 are trimmed so as to expose the optical fiber 20 and a relatively shorter length of the strength members 18 (see FIG. 2). In an exemplary embodiment and as discussed above, the strength members 18 includes a plurality of aramid yarns 24 surrounding the optical fiber 20. The trimming module 66 of the apparatus 60 is configured to efficiently handle the strength members 18 and reduce their length to the desired length for connection to the connector 14.

Accordingly, the trimming module 66 of the apparatus 60 includes a collection system 150 for handling the plurality of strength members 18 after the outer jacket 16 has been stripped from the cable 12. In an exemplary embodiment, the collection system 150 includes a vacuum tube 152 having an end 154 positioned in close proximity to the cable 12 (see FIGS. 7A-8B). More particularly, the end 154 of the vacuum tube 152 may be positioned to a side of the cable 12 adjacent to the front cable clamp 74. Other positions along the end section 116 of the cable 12 may also be possible but it is preferred that the vacuum tube 152 be positioned close to the front cable clamp 74. Additionally, in an exemplary embodiment, the vacuum tube 152 may extend away from the cable 12 in a direction generally parallel to the direction of movement of the clamp heads 90, 92 of the rear cable clamp 76. Thus, for example, the vacuum tube 152 may extend from the cable 12 in a generally horizontal direction. Other directions, however, are possible. Moreover, while only a single vacuum tube 152 is illustrated in the figures, it should be recognized that the trimming module 66 may include additional vacuum tubes disposed about the cable 12 for handling at least some of the strength members 18.

The vacuum tube 152 may be coupled to a vacuum pump 156 for drawing a vacuum at the end 154 of the tube 152 (FIG. 6B). The vacuum pump 156 may be energized prior to (e.g., just prior to), at the same time as, or just subsequent to the outer jacket 16 being stripped off the cable 12 by the movement of the rear cable clamp 76 and the cable guide 78 along the longitudinal axis 138 of the cable 12. In this way, the strength members 18 are collected by the vacuum tube 152 as the members 18 are freed from the outer jacket 16. More particularly, as the strength members 18 are freed from the outer jacket 16, the strength members 18 are drawn into the vacuum tube 152 as a result of the suction at the end 154 of the vacuum tube 152. The vacuum pressure generated by the pump 156 is sufficient to draw the strength members 18 into the vacuum tube 152 but not significantly deflect the optical fiber 20 in a direction toward the vacuum tube 152. For example, the vacuum pump 156 may be configured to generate a pressure of between about 50 psi and about 70 psi at the end 154 of the vacuum tube 152 for collecting the strength members 18, These values, however, may be appropriately adjusted to other values depending on the particular application. In any event, the strength members 18 gathered by the collection system extend in a direction transverse to the cable 12. For example, the gathered strength members 18 may extend in a direction perpendicular to the longitudinal axis 138 of the cable 12 (FIG. 86).

With the strength members 18 collected by collection system 150, the trimming module 66 may be configured to sever the strength members 18 at a second separation location or cutline 160 so as to separate an end section 162 of the strength members 18 from the main portion 118 of the cable 12 (and more particularly from the strength members 18 of the main portion 118 of the cable 12). To provide a high-quality separation of the strength members 18 at the cutline 160, the strength members 18 may be put under some tension such that the strength members 18 are held by the collection system 50 in a taut state. This may be achieved, for example, by the pressure imposed by the vacuum pump 156 at the end 154 of the vacuum tube 152, In other words, not only does the collection system 150 collect the plurality of strength members 18 to a side of the cable 12 (e.g., in a direction 90 degrees offset from the longitudinal axis 138), the collection system 150 also pulls the strength members 18 to such a degree that a certain amount of tension exists in the strength members 18. By way of example, the vacuum pump 156 may be configured to generate a tension of at least 2 lbs. Thus, at this point, the strength members 18 have been collected and suitably tensioned in preparation for being separated at the cutline 160.

Before doing so, however, the vacuum tube 150 may be repositioned in order to expose the desired cutline 160 in the strength members 18. When collecting the strength members 18 upon stripping the outer jacket 16 from the cable 12, it may be advantageous to position the end 154 of the vacuum tube 152 in close proximity to the cable 12 and adjacent the front cable clamp 74 (FIGS. 7B and 8B), It is believed that this location offers the best opportunity to collect the strength members 18. In this location, however, the desired cutline 160 in the strength members 18 may not be exposed but may be positioned inside the vacuum tube 152. Additionally, with the presence of the vacuum tube 152 so close to the cable 12 and front cable clamp 74, there may not be sufficient room to position the equipment necessary to perform the separation of the strength members 18 at the cutline 160.

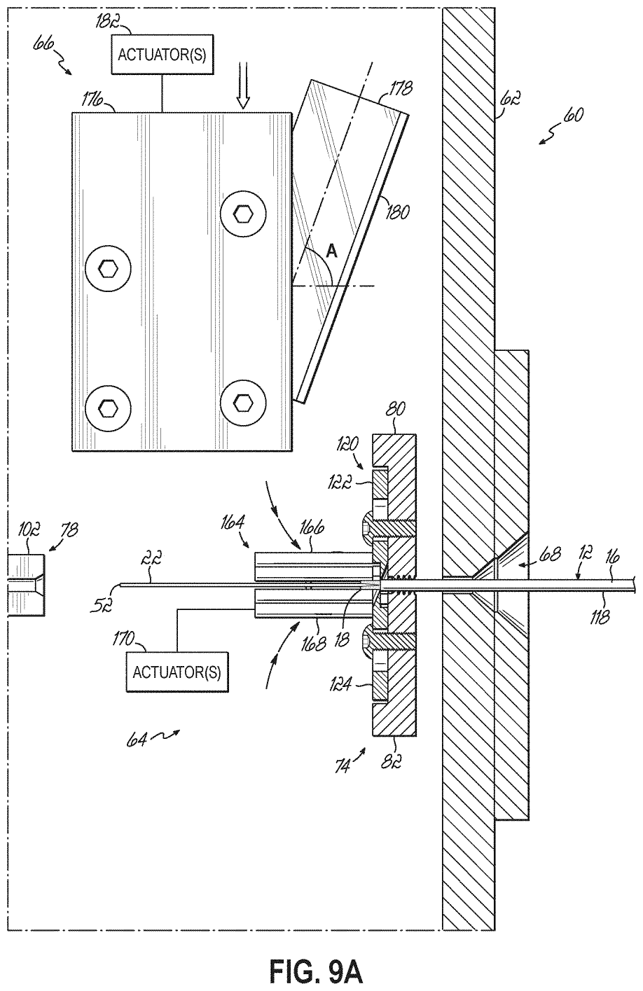

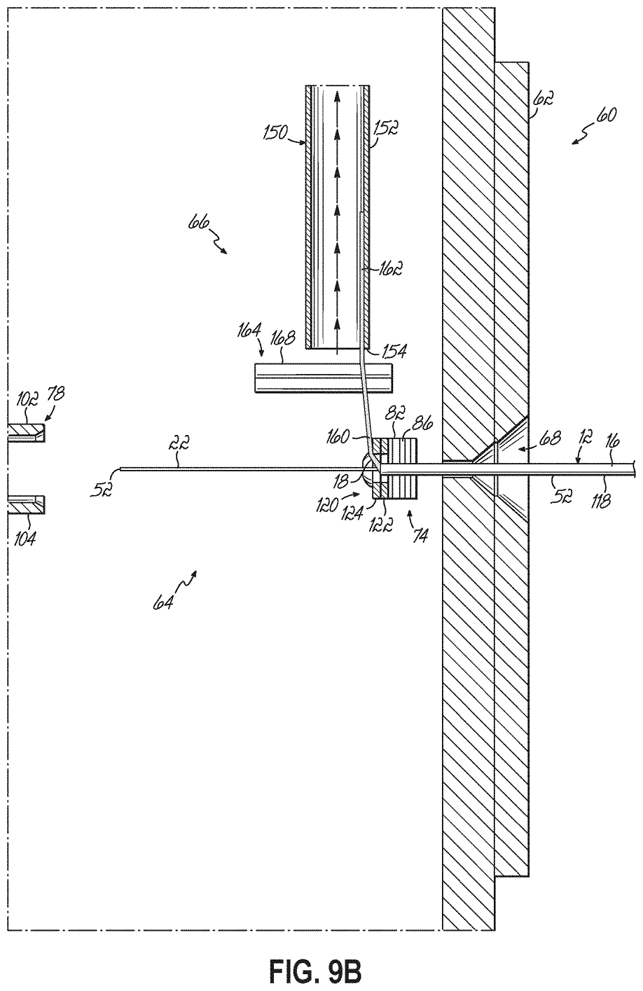

Thus, the vacuum tube 152 may be configured to move away from the cable 12 in order to create sufficient space for achieving the separation of the strength members 18 at the desired cutline 160. More particularly, in an exemplary embodiment the vacuum tube 152 is configured to be retractable in a direction along which the vacuum tube 152 extends (e.g., in the horizontal direction) so that the end 154 of the vacuum tube 152 moves away from the cable 12 (FIG. 9B). It should be appreciated, however, that during the retraction of the vacuum tube 152, the vacuum pump 156 may continue to be energized such that the strength members 18 remain collected and under tension due to the vacuum pressure of the collection system 150. For example, the collection system 150 may include one or more actuators for moving the vacuum tube 152 between an extended position (FIG. 8B) and a retracted position (FIG. 9B).

While the collection system 150 is configured to provide a certain amount of tension in the strength members 18, the vacuum pressure from the pump 156 may not be sufficient to hold the strength members 18 during the physical severing of the strength members 18 at the cutline 160. Thus, the trimming module 66 may also include a fiber clamp assembly 164 for more securely retaining the strength members 18 in preparation for being separated at the cutline 160 (FIG. 9A). In one embodiment, the clamp assembly 164 includes a pair of clamp heads 166, 168 off to a side of the cable 12 (e.g., the same side as the vacuum tube 152) but on opposing sides of the collected strength members 18. The clamp heads 166, 168 may be coupled to one or more actuators 170 for moving the clamp heads 166, 168 relative to each other. For example, the actuators 170 may be configured to move the clamp heads 166, 168 toward and away from each other to define a closed and opened position, respectively. In one embodiment, both clamp heads 166, 168 may be movable. In an alternative embodiment, however, one clamp head 166, 168 may be stationary while the other clamp head is movable.

In the opened position, the clamp heads 166, 168 are spaced apart from each other a sufficient amount such that the vacuum tube 152 is allowed to pass by the clamp heads 166, 168 without interference. In the closed position, the clamp heads 166, 168 engage the strength members 18 to hold and secure their position. For this purpose, the faces of the clamp heads 166, 168 may include gripping features 172, such as ridges, undulations, irregularities, coatings, pads, etc., to enhance the engagement of the clamp heads 166, 168 to the strength members 18. The actuators 170 are configured to provide a clamping force or pressure sufficient to retain the tension in the strength members 18 from the collection system 150 and to secure the strength members 18 during the severing process. Those of ordinary skill in the art will understand how to adjust the clamping force or pressure to achieve sufficient securement of the strength members 18.

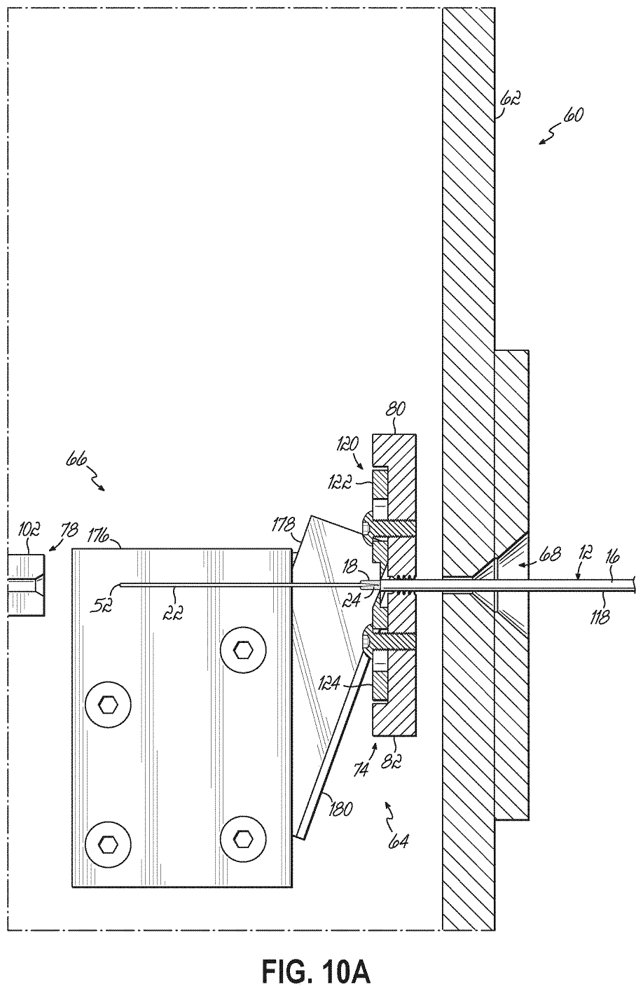

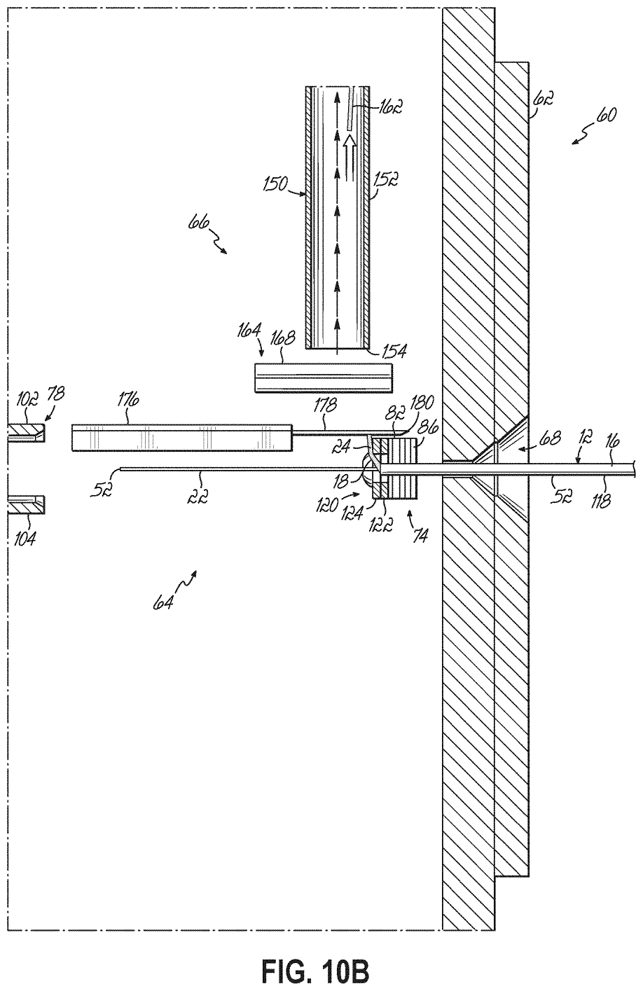

After the vacuum tube 152 has been retracted such that the end 154 of the vacuum tube 152 is outboard of the clamp heads 166, 168, the actuators 170 of the fiber clamp assembly 164 may be energized to secure the strength members 18 between the clamp heads 166, 168. To separate the strength members 18, the trimming module 66 may include a cutting assembly 176 having a blade 178 that defines a cutting edge 180 for engaging with strength members 18 (see FIGS. 9A-10B), In an exemplary embodiment, the cutting assembly 176 is movable within the housing 62 of the apparatus 60. This allows the cutting assembly 176 to be out of the way for the stripping process of the stripping module 64 and the collection process of the trimming module 66. However, after the vacuum tube 152 has been moved out of the way, the cutting assembly 176 is able to move into position to effectuate a separation of the strength members 18 at the cutline 160.

For example, the cutting assembly 176 may be coupled to one or more actuators 182 for moving the cutting assembly 176 between a retracted position (FIG. 9A) and an extended position (FIG. 10A). In an exemplary embodiment, the cutting assembly 176 may be positioned generally above the front cable clamp 74 and vacuum tube 152 (i.e., generally above the cable 12 when the cable is positioned in the housing 62) and the actuators 182 may be configured to move the cutting assembly 176 downwardly in a generally vertical direction. Thus, after the vacuum tube 152 has been retracted and the fiber clamp assembly 164 engaged, the actuators 182 may be energized to move the cutting assembly 176 downwardly so that the cutting edge 180 of the blade 178 engages and separates the strength members 18 at the desired cutline 160. To achieve a high-quality cut at the cutline 160, the cutting edge 180 of the blade 178 may approach the strength members 18 at a specified angle of attack, as illustrated by angle A in FIG. 9A, for example. The strength members 18 are intended to be strong, tough fibers in order to adequately protect the optical fiber 20. Thus, simply bringing a blade down in a straight perpendicular manner (i.e., at an angle of attack of 90 degrees in the reference frame of FIG. 9A) may not result in a clean separation at the cutline 160 due to the toughness of the strength members 18. It is believed that by engaging the strength members 18 at an acute angle of attack less than 90 degrees, the strength members 18 may more easily sever or cut. For example, in an exemplary embodiment, the angle of attack of the cutting edge 180 of the blade 178 may be between about 15 degrees and about 30 degrees, and more preferably between about 20 degrees and 25 degrees.

After the strength members 18 have been separated at the cutline 160, the cutting assembly 176 may be retracted by actuators 182 so as to be moved back out of the way. Additionally, the end section 162 of the strength members 18, which are now loose from the main portion 118 of the cable 12, may be collected by the collection system 150. More particularly, the end section 162 of the strength members 18 may be pulled into the vacuum tube 152 and delivered to a collection bin (not shown) positioned within the housing 162 of the apparatus 160. Periodically, the bin may be removed from the housing 62 and the contents appropriately discarded. Thus, trimming of the strength members 18, in this case the fibers 24, may be a clean and organized process.

After the trimming of the strength members 18, the front cable clamp 74 may be moved to its opened position, thereby releasing the cable 12 from the apparatus 60. The technician may then remove the cable 12 from the housing 62. The now processed end of the cable 12 has a length of optical fiber 20 extending from the outer jacket 16 and a length of strength members 18 extending from the outer jacket 16 but for a length less than the length at which the optical fiber 20 extends from the outer jacket 16. The fiber optic cable 12 is now ready to begin the termination process that involves installing the connector 14 and thereby forming the fiber optic cable assembly 10, as illustrated in FIGS. 1 and 2 and described above.

As can be appreciated from the above description, the apparatus 60 relies on relatively little manual input. Besides inserting and removing the cable 12 from the housing 62 of the apparatus 60, the remaining steps for stripping the cable 12 and trimming the strength members 18 does not rely on manual input but instead are implemented in an automated process performed by the apparatus 60. Accordingly, the issues associated with manual processes, including dependence on the skill and experience of the technician and the inherent inconsistencies of manual processes, may be avoided. Moreover, the apparatus 60 performs multiple functions within the same piece of equipment (e.g., housing 62). More particularly, essentially within one operational step (i.e., inserting the cable 12 into the apparatus 60) both the stripping and trimming processes are performed and the outcome is a cable 12 ready to be connected to a connector 14. The process is therefore more efficient, resulting in lower cycle times and higher throughput.

To facilitate operation of the apparatus 60, the apparatus 60 may include a controller 188 (FIG. 3) for controlling the various components and processes of the apparatus 60. For example, the controller 188 may be coupled to the stripping module 64 and the trimming module 66 for controlling their operation. More particularly, the controller 188 may be coupled to the front cable clamp 74, rear cable clamp 76, cable guide 78, and blade assembly 120, as well as their respective actuators 84, 94, 106 for controlling the stripping of the outer jacket 16 from the cable 12. The controller 188 may further be coupled to the collection system 150, clamp system 160 and cutting assembly 176, as well as their respective actuators 158, 170, 182 for controlling the trimming of the strength members 18.

The controller 188 may include an input device, such as a keyboard, touchscreen, smart phone, etc. for inputting certain data into the apparatus 60. For example, the input device may be used to identify the size of the cable 12 being processed and the type of connector 14 that will be coupled to the cable 12. The controller 188 may then configure the apparatus 60 according to preset criteria and parameters based on the selected cable size and/or connector type. For example, the input data may determine the distance between the front and rear cable clamps 74, 76 (e.g., the exposed length of optical fiber), the pressure at which the various clamp heads engage the cable 12 or strength members 18, the amount of vacuum pressure generated by the collection system 150, the position of the outline 160 for the strength members 18 (e.g., the exposed length of the strength members 18), and other operational parameters for facilitating the processes carried out by the apparatus 24. Those of ordinary skill in the art will understand how to configure the controller 188 to accommodate the various possibilities in cable type and connector type. Accordingly, further detail on the controller will not be provided herein.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

1. An apparatus for processing a fiber optic cable for connection to a fiber optic connector, the fiber optic cable including an outer jacket, strength members, and at least one optical fiber, the apparatus comprising:
a housing having an inlet for receiving an end of the fiber optic cable, the inlet providing access to a fiber optic cable path for the fiber optic cable in the housing;
a stripping module positioned in the housing and configured to remove an end section of the outer jacket from the end of the fiber optic cable to provide exposed portions of the strength members and an exposed portion of the at least one optical fiber; and
a trimming module positioned in the housing and configured to remove an end section of the exposed portions of the strength members.

2. The apparatus of claim 1, wherein the stripping module comprises:
at least one cable clamp configured to at least partially secure the fiber optic cable relative to the housing; and
a blade assembly configured to separate the end section of the outer jacket from a main portion of the fiber optic cable at a first location.

3. The apparatus of claim 2, wherein the at least one cable clamp comprises:
a first cable clamp positioned adjacent the inlet of the housing; and
a second cable clamp spaced from first cable clamp, wherein the second cable clamp is configured to engage the fiber optic cable adjacent the end of the fiber optic cable.

4. The apparatus of claim 3, wherein the stripping module further comprises a cable guide positioned between the first and second cable clamps and configured to at least partially support the fiber optic cable within the housing.

5. The apparatus of claim 4, wherein the cable guide comprises:
a pair of guide portions positioned on opposing sides of the fiber optic cable path; and
a cable guide actuator for moving the pair of guide portions relative to each other between an opened position and a closed position, wherein the pair of guide portions are configured to at least partially support the fiber optic cable in the closed position of the pair of guide portions.

6. The apparatus of claim 3, wherein:
the first cable clamp comprises:
a first pair of clamp heads positioned on opposing sides of the fiber optic cable path; and
a first cable clamp actuator for moving the first pair of clamp heads relative to each other between an opened position and a closed position, wherein the first pair of clamp heads is configured to engage the fiber optic cable in the closed position of the first pair of clamp heads; and
the second cable clamp comprises:
a second pair of clamp heads positioned on opposing sides of the fiber optic cable path; and
a second cable clamp actuator for moving the second pair of clamp heads relative to each other between an opened position and a closed position, wherein the second pair of clamp heads is configured to engage the fiber optic cable in the closed position of the second pair of clamp heads.

7. The apparatus of claim 6, wherein the direction of movement of the first pair of clamp heads between the associated opened and closed positions is different than the direction of movement of the second pair of clamp heads between the associated opened and closed positions.

8. The apparatus of claim 7, wherein the direction of movement of the first pair of clamp heads and the direction of movement of the second pair of clamp heads are offset by about 90 degrees.

9. The apparatus of claim 6, wherein the blade assembly comprises:
a pair of blade bodies positioned on opposing sides of the fiber optic cable path, wherein each blade body includes a cutting edge configured to engage the fiber optic cable and separate the end section of the outer jacket from the main portion of the fiber optic cable, and wherein each blade body of the pair of blade bodies is mounted to a respective clamp head of the first pair of clamp heads.

10. The apparatus of claim 9, wherein each blade body of the pair of blade bodies is adjustably mounted to the respective clamp head of the first pair of clamp heads.

11. The apparatus of claim 2, wherein the trimming module comprises:
a collection system positioned to a side of the fiber optic cable path for gathering the exposed portions of the strength members; and
a cutting assembly configured to separate the end sections of the exposed portions of the strength members at a second location.

12. The apparatus of claim 11, wherein the collection system comprises:
a vacuum tube having an inlet end positionable adjacent the fiber optic cable path; and
a vacuum pump coupled to the vacuum tube for generating suction at the inlet end of the vacuum tube.

13. The apparatus of claim 12, wherein the vacuum tube extends in a direction generally transverse to the fiber optic cable path.

14. The apparatus of claim 12, wherein the collection system further comprises an actuator for moving the vacuum tube between an extended position and a retracted position, wherein the inlet end of the vacuum tube is adjacent the fiber optic cable path in the extended position and is spaced from the fiber optic cable path in the retracted position.

15. The apparatus of claim 11, wherein the trimming module further comprises a clamp assembly positioned to a side of the fiber optic cable path and configured to at least partially secure the exposed portions of the strength members gathered by the collection system, and wherein the clamp assembly is positioned on the same side of the fiber optic cable path as the collection system.

16. The apparatus of claim 15, wherein the clamp assembly comprises:
a pair of clamp heads configured to be positioned on opposing sides of the collection system; and
a clamp assembly actuator for moving the clamp heads relative to each other between an opened position and a closed position, wherein the clamp heads are configured to engage the strength members gathered by the collection system in the closed position.

17. The apparatus of claim 16, wherein the vacuum tube is extendable between the pair of clamp heads of the clamp assembly when the clamp heads of the clamp assembly are in the opened position.

18. The apparatus of claim 11, wherein the cutting assembly further comprises a blade having a cutting edge configured to engage the strength members gathered by the collection system and separate the end sections of the exposed portions of the strength members at the second location.

19. The apparatus of claim 18, wherein the trimming module further comprises an actuator for moving the cutting head between an extended position and a retracted position, the cutting edge of the blade configured to engage the strength members gathered by the collection system when the cutting head is in the extended position.

20-30. (canceled)
